(19) United States
(12) Patent Application Publication
(10) Pub. No.: US 2015/0096368 A1
(43) Pub. Date: Apr. 9, 2015

(54) System, Method, and Apparatus for Determining Soil Density

(71) Applicant: Matthew O'Brien, Wesley Chapel, FL (US)

(72) Inventor: Matthew O'Brien, Wesley Chapel, FL (US)

(21) Appl. No.: 14/046,259

(22) Filed: Oct. 4, 2013

(51) Int. Cl. G01N 9/00

(52) U.S. Cl. CPC G01N 9/00
USPC 73/32 A; 73/32 R

(57) ABSTRACT

A system for measuring soil density includes a plurality of signal emitters paired with signal receivers situated within the soil and below grade (e.g. from 10 to 30 feet below grade). The emitters periodically emit the signal (e.g., ultrasonic signal), some of which is reflected back by the soil. If the soil is compact and close to the emitter/receiver, the reflected signal is received after a short delay and has high signal strength. If the soil is less compact or there is a gap between the soil and the emitter/receiver, the reflected signal is received after a greater delay and/or has lower signal strength. By making several measurements of the delay and signal strength, a baseline is established. Later, periodic measurements of the delay and signal strength are made. If the delay and/or signal strength measured differs from the baseline, the soil density has likely changed.

### FIELD

This invention relates to the field of soil management and more particularly to a system for measuring the soil density.

### BACKGROUND

There are many reasons to measure soil density. Besides the general geological reasons, measuring soil density is one way to detect the potential for sink hole development.

A sinkhole is a collapse of soil in a particular location, typically forming a bowl-shape. It is believed that sink holes form when a void occurs under the surface and there is insufficient soil crusting to support the upper layers of soil resulting in the formation of a depression. If houses or other buildings are in the proximity of this sink hole, they are drawn into the sink hole, causing property damage and, because the depression occurs quickly, potentially bodily injury. There is typically very little warning of a sink hole forms.

There are two types of sink holes. The first type is a cover-subsidence sinkhole. In such, soil transports itself into a cave in rock and the ground slowly subsides. These are not catastrophic because the soil subsides over longer periods of time, from years to maybe thousands of years.

The other type of sink hole is a cover-collapse sinkhole. Cover-collapse sink holes make the news because of the destruction and injury that often results. One such sink hole opened suddenly at a resort in Clermont Fla., causing major damage to the resort, but luckily, resulting in no bodily injury. Unfortunately, a little earlier, a 20 foot sink hole opened beneath a sleeping man, killing that man. Cover-collapse sink holes tend to form in clay, because the clay holds soil together like glue. Soil leaching creates a void in the lower soil layers and the void then grows upward and, because of the clay, a bridge forms over the void. At some point, the bridge can't hold anymore and it collapses, taking with it any structures or people from above the bridged surface.

Although sink holes have the potential of forming anywhere, many cover-collapse sink holes occur in Florida and Texas. To date, it has been almost impossible to predict a forming sink hole. There are little signs of a pending sink hole. Often, potential indications are fresh cracks in the foundations of houses and buildings or the skewing of a door frame making it difficult to close or open a door. Many people in areas of high risk for sink holes are required to have insurance to cover property losses due to sink holes, but insurance is meaningless when lives are lost.

What is needed is a system that will effectively predict the possibility of a forming sink hole.

### SUMMARY

A system for measuring soil density includes a plurality of signal emitters paired with signal receivers (e.g., ultrasonic emitters and receivers) situated within the soil and below grade (e.g. from 10 to 30 feet below grade). The emitters periodically emit the signal, some of which is reflected back by the soil. If the soil is compact and close to the emitter/receiver, the reflected signal is received after a short delay and has high signal strength. If the soil is less compact or there is a gap between the soil and the emitter/receiver, the reflected signal is received after a greater delay and/or has lower signal strength. By making several measurements of the delay and signal strength, a baseline is established. After such, periodic measurements of the delay and signal strength are made. If the delay and/or signal strength measured is significantly different than the baseline, then the soil density has likely changed, possibly indicating a developing sink hole.

In one embodiment, a soil density monitoring system is disclosed including a sensor pair having an emitting device and a receiving device. The emitting device emits a signal at a first time and the signal is reflected by soil and a reflected signal is detected by the receiving device at a second, later time. The sensor pair is positioned below grade (e.g. between 10 and 30 feet below grade) such that a signal strength of the reflected signal and a signal delay between the first time and the second time are measured as an indication of the soil density.

In another embodiment, a method of determining changes in soil density is disclosed including (a) providing at least one sensor pair comprising a signal emitter and signal receiver and (b) installing the at least one sensor pair in soil below grade level (e.g. between 10 feet and 30 feet below grade). (c) One of the signal emitter is enabled to emit a signal and at least some of the signal reflects off of the soil towards the signal receiver where (d) the reflected signal is received by the signal receiver. (e) A signal strength and signal delay which is the time between the enabling and the receiving is recorded for determination of changes in soil density.

In another embodiment, a soil density monitoring system is disclosed including a computer system and at least one sensor array. The sensor array(s) are located (or positioned) within the soil below a grade (e.g., from 10 feet to 30 feet below grade). Each sensor array includes one or more pairs of emitting devices and receiving devices. The emitting devices emit a signal at a first time (T₀), the signal is reflected by soil, and a reflected signal strength is detected by the receiving device at a second, later time (T₁). A signal delay is the difference between the first time and the second time. The pairs of the emitting devices and the receiving devices are operatively connected (e.g. wired, wireless) to the computer system. Software executing in a tangible memory of the computer system reads the reflected signal strengths and the signal delays. The reflected signal strengths and delays are related to a density of the soil in vicinity of each of the pairs of the emitting devices and the receiving devices.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a soil density detection system.

FIG. 2 illustrates a second schematic view of the soil density detection system.

FIG. 3 illustrates a perspective view of a sensor array of the soil density detection system.

FIG. 4 illustrates a schematic view of a typical placement of sensor arrays for soil density detection system.

FIG. 5 illustrates a schematic view of a system for soil density detection system.

FIG. 6 illustrates a flow chart of software of the soil density detection system.

FIG. 7 illustrates a second flow chart of software of the soil density detection system.

FIG. 8 illustrates a third flow chart of software of the soil density detection system.

FIG. 9 illustrates an exemplary histogram chart as read by sensors of the soil density detection system.

FIG. 10 illustrates a second exemplary histogram chart as read by sensors of the soil density detection system.

FIG. 11 illustrates a schematic view of a typical computer system of the soil density detection system.

FIG. 12 illustrates a schematic view of an exemplary controller of the soil density detection system.

FIG. 13 illustrates a schematic view of an exemplary wired sensor array of the soil density detection system.

FIG. 14 illustrates a schematic view of a second exemplary wireless sensor array of the soil density detection system.

FIG. 15 illustrates a schematic view of an exemplary wireless sensor array of the soil density detection system.

FIG. 16 illustrates a schematic view of an exemplary notification transmission of the soil density detection system.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

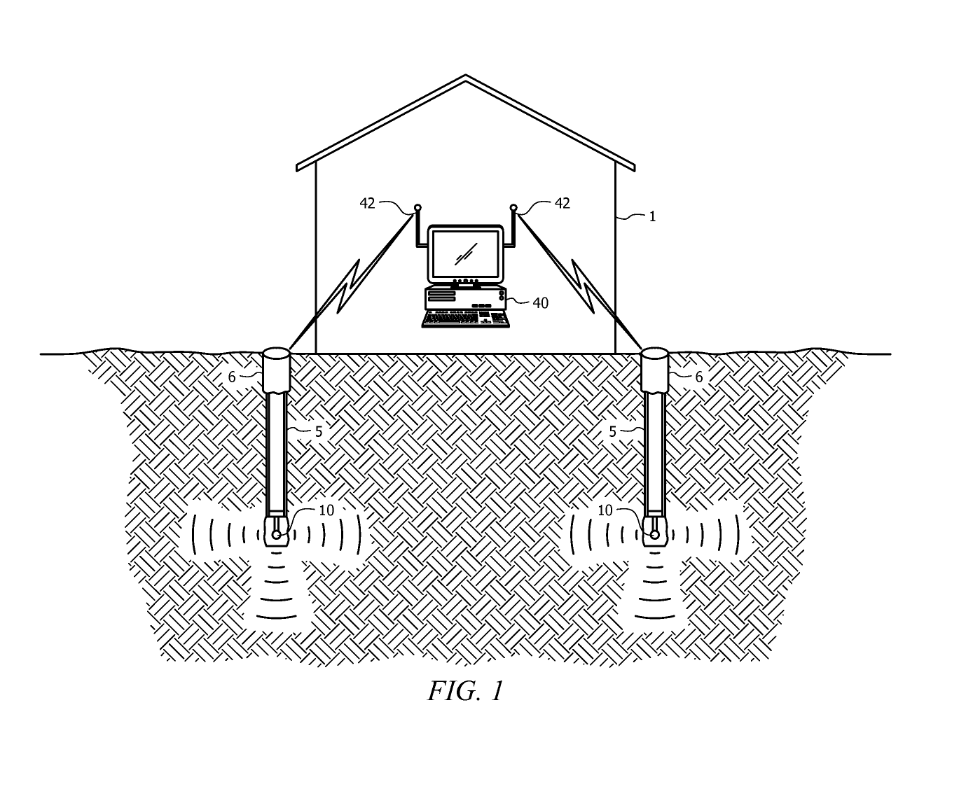

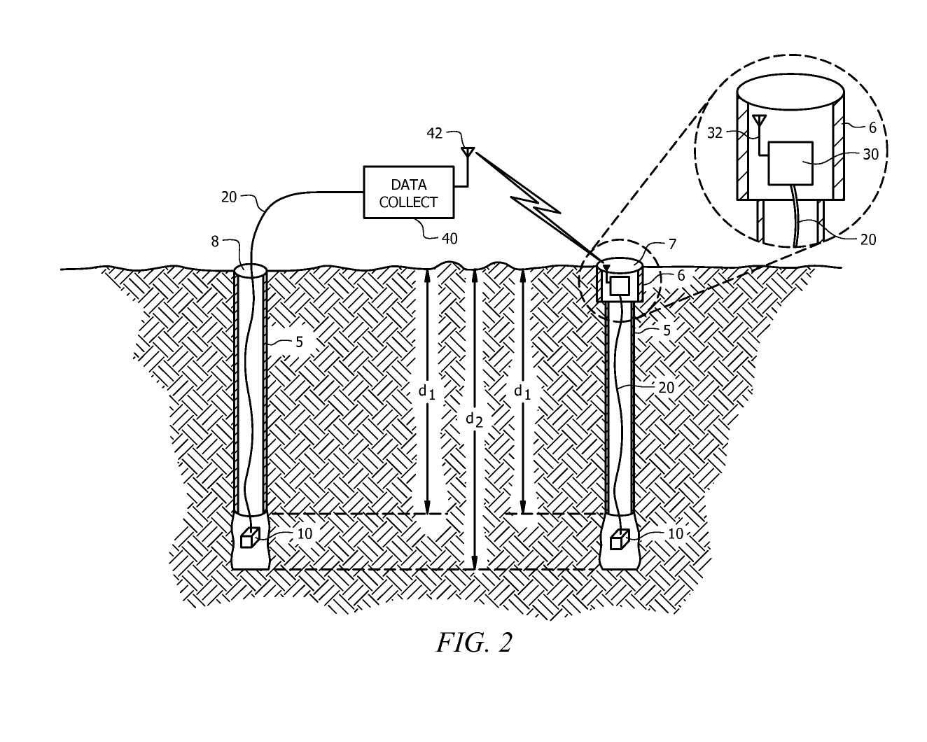

Referring to FIG. 1, a schematic view of a soil density detection system is shown. The soil density detection system includes one or more sensor arrays 10 embedded in the soil and a controller or computer 40 for processing signals from the one or more sensor arrays 10. The controller 40 is preferably housed within a structure 1 (e.g. a house 1). In FIG. 1, all of the sensor arrays 10 connect to the controller 40 through a wireless transmission within a housing 6 (see FIG. 2 for details). In some embodiments, a conduit (e.g. PCV pipe) 5 provides for wiring to the sensor array 10. Wireless signals from the sensors sensor array 10 and wireless transmitter 30 (see FIG. 2) are received on one or more antenna 42 and then processed by the controller 40. In other embodiments (as will be shown), some or all of the sensor arrays 10 are connected by wire(s) connecting the sensor arrays 10 to the controller 40.

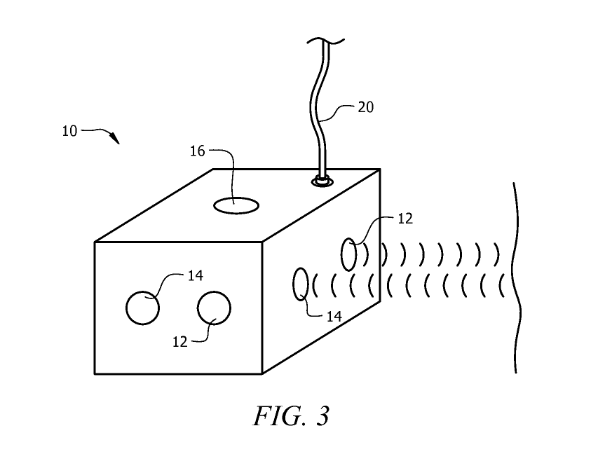

Referring to FIG. 2, a second schematic view of the soil density detection system is shown. In this example, more details of the sensor arrays 10 are shown. One sensor array 10 is directly connected to the controller 40 through a cable 20, while another sensor array 10 is connected to a wireless transmitter (or transceiver) 30 and antenna 32 by one or more wires 20. In the later, data regarding the individual sensors 12/14/16 (see FIG. 3) is communicated between the sensor array 10 and the wireless transmitter (or transceiver) 30 on one or more wires, either by direct connection, sequenced connection, a bus architecture, or any other connection known. The wireless signal is transmitted from the antenna 32 to a second antenna 42 interfaced to a receiver within the controller 40 (not shown). Note, although a radio frequency wireless transmission is shown, any type of wireless transmission is anticipated, including wireless transmission using light, sound, etc.

It is anticipated, but not required, that the transmitter 30 be housed in a covered box 6, either on, at, or below grade. Since the transmitter 30 is preferably battery powered, it is also preferred that the box 6 have a removable cover 7 for battery replacement. In a preferred embodiment, a section of conduit 5 (e.g. PVC pipe) provides a channel for the wire(s) 20. In embodiments in which there is a direct connection of the sensor array 10 to the controller 40 by wires 20, it is anticipated, though not required, that a cover 8 be installed at the upper end of the conduit 5, either removable or fixed.

In the example shown in FIG. 2, a typical placement of the sensor arrays 10 is shown. In this example, the conduit 5 is pushed into the soil to a distance d₂, and then the conduit is retracted so a bottom rim of the conduit 5 is at a lesser distance into the soil, d₁. In this way, the sensor arrays 10 sit within the soil in a location deeper than d₁ but shallower than d₂, thereby the sensor arrays 10 are not blocked by the conduit 5. Any system of placement is anticipated and the present invention is in no way limited to any placement mechanism or conduit system.

As will be shown in FIG. 3, the sensor arrays 10 have sensors 12/14/16, a first part of the sensors 12/14/16 being an emitter 12 that emit signals (e.g. ultrasonic sound) and a second part of the sensors 12/14/16 being a detector 14 that provides an electrical signal indicative of the timing and strength of reflections of the emitted signal back from the surrounding soil. The more dense the soil, the quicker the reflections are received and the greater magnitude of the reflections. In some embodiments, the sensor arrays 10 include a humidity/moisture sensor 16 that provides an electrical signal indicative of the moisture content of the surrounding soil.

As an example of an installation, for one certain water table depth, the conduit 5 is sunk 21 feet, and then pulled back one foot, leaving the sensor array 10 at approximately just under 21 feet beneath the surface.

Although there is no restriction on depth, it is anticipated that there is no need to place the sensor array 10 more than 18-20 feet beneath the surface because, typically, 18-20 feet of soil is self-supportable, in that, that much soil thickness will hold a typical home even if there is a total void below the 20 foot depth. This does not preclude installation at depths greater than 20 feet, such as 30 feet.

In locations with high water tables, it is anticipated, but not required, that the sensor array 10 is placed at depths that are above the average water table depth so that any density readings are not skewed by the sensor array 10 being surrounded by water, though it is also anticipated to install the sensor array 10 at any depth. In some embodiments, one or more sensor arrays are positioned below the water table, etc.

Referring to FIG. 3, a perspective view of a sensor array 10 of the soil density detection system is shown. Although shown as a particular 6-sided shape, the sensor array 10 is not limited to any specific size or shape. In this example, density sensor pairs 12/14 are located on four sides (90 degrees apart from each other) of the sensor array 10 (only two are visible), providing readings from four different directions. In other embodiments, more or less pairs of sensors 12/14 are utilized to provide greater coverage or lesser coverage, as needed. As shown with the sensor pair 12/14 to the right of this view, the emitter 12 emits a signal (e.g. an ultrasonic noise burst) and the detector 14 receives a reflected signal, converts the reflected signal to an electrical signal that is relayed to the controller 40 through the wire(s) 20 and/or the transmitter 30. The electrical signal is used to determine the time delay and signal strength of that reflected signal. The greater the soil density, the shorter the delay and/or the greater the signal strength of the received reflected signal. For example, if a sink hole begins to form next to this sensor pair 12/14 of the sensor array 10, there will be a void next to the sensor 12/14 and the reflected signal will have a lower strength. Also, the signal will have to travel farther before it is reflected; hence the delay between transmission and reception will increase.

Many types of density sensor pairs 12/14 are anticipated. The preferred density sensor pairs 12/14 include an ultrasonic emitter 12 and an ultrasonic detector 14 as used, for example, in electronic yard sticks, fish finders, sonar, etc. Although this type of density sensor pairs 12/14 is preferred, other density sensor pairs 12/14 are anticipated including density sensor pairs 12/14 that use non-ultrasonic sound, radio frequencies, light, etc.

In a preferred embodiment, though not required, a moisture/humidity sensor 16 is employed to measure the soil moisture content in the vicinity of the sensor array 10. When present, the moisture/humidity sensor 16 detects moisture and converts the amount of moisture into an electrical signal. The electrical signal representative of moisture content from the moisture/humidity sensor 16 is relayed to the controller 40 to adjust readings that may vary due to, for example, excess rain. In times of high rain, rain water leeches through the soil and surrounds the sensor arrays 10, changing the signal strength and time delay of the signals even though no soil movement occurs.

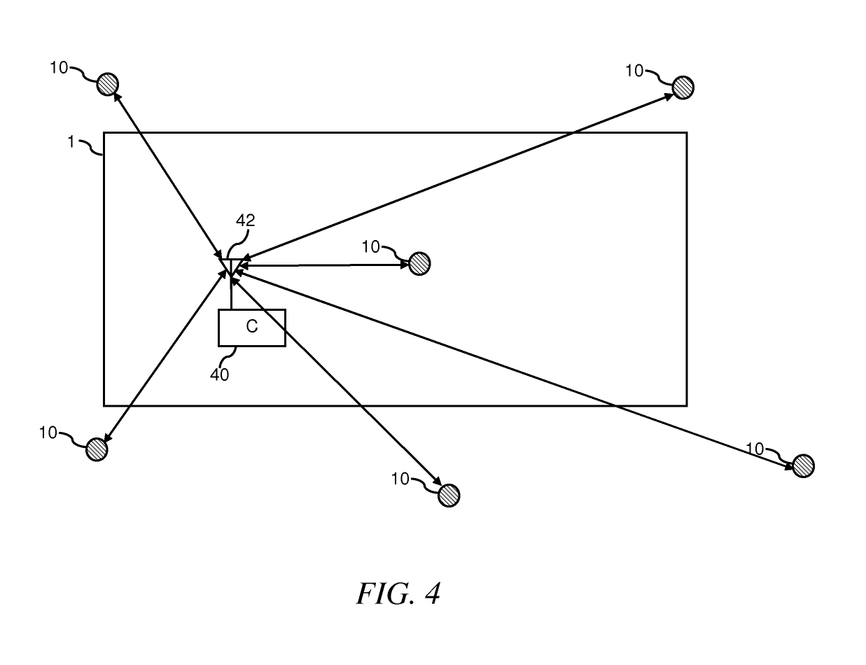

Referring to FIG. 4, a schematic view of a typical placement of sensor arrays 10 for soil density detection system is shown. In this example, one sensor array 10 is set roughly at each corner of the building 1 and one extra sensor array 10 is set between two corners of the building 1, as obstacles such as trees, decks, porches, etc., permit. In some installations, one or more sensor arrays 10 are set beneath the building 1, depending upon the size of the building 1. It is known how to place objects beneath a building 1 (or other obstruction such as decks, trees, porches, etc.) by drilling or planting on angle or in an ‘S’ fashion, often known as directional drilling. Additionally, for certain structures 1, it is also anticipated that there is access to the grade beneath the structure 1 through crawl spaces, etc., through which the sensor arrays 10 are then set.

Note that the present invention is not limited to any particular configuration or quantity of sensor arrays 10.

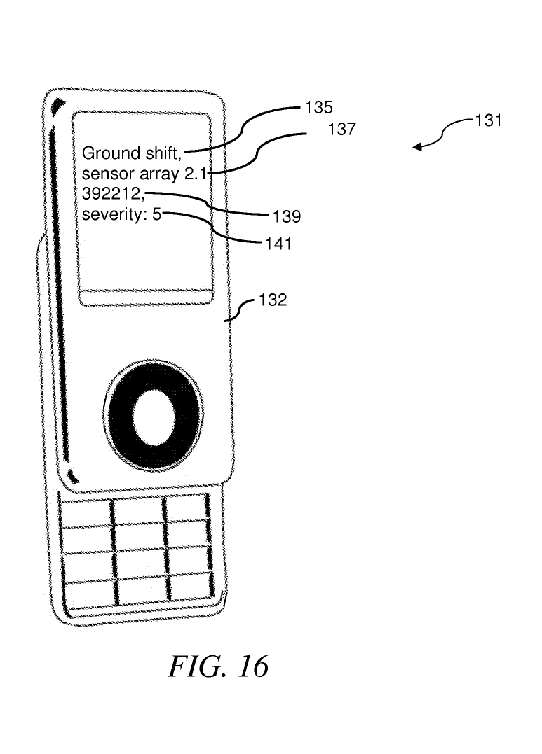

It is anticipated that each sensor array 10 have identification such as a serial number, sequence number, etc. During installation, the installation process preferably includes mapping of such identification to a sensor array number and/or an individual sensor 12/14/16 within the sensor array 10. The sensor array number and/or individual sensor number is then used in communications such as notifications 131 (see FIG. 16) to identify with sensor array 10 or sensors 12/14/16 have detected an issue.

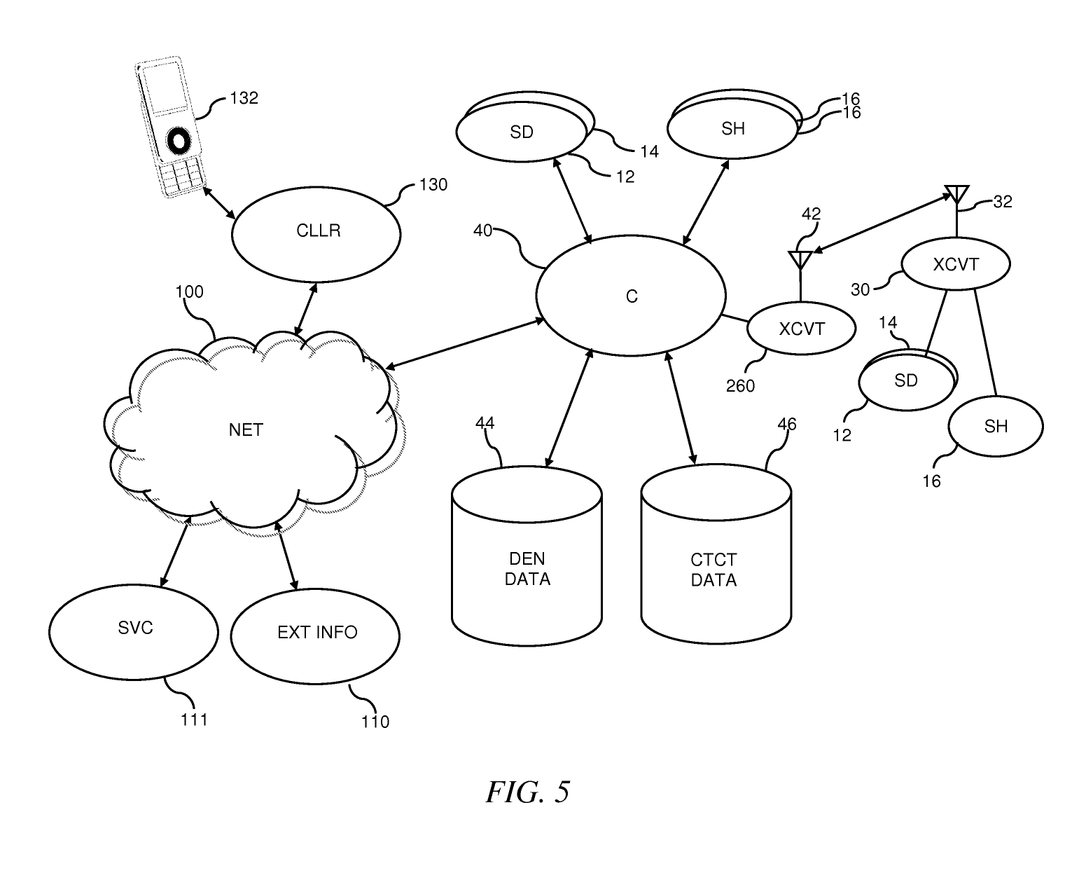

Referring to FIG. 5, a schematic view of a system for soil density detection system is shown. In the center of this exemplary configuration is a controller (or computer) 40. In other configurations more or less components are present, as required. The controller 40 is coupled to one or more sensor arrays 10, for example, directly coupled to several density sensors 12/14 and humidity sensors 16. Several other density sensors 12/14 and humidity sensors 16 are indirectly coupled to controller 40 through one or more transmitters 30 or transceivers 30 communicating to one or more receivers 260 or transceivers 260 connected to the controller 40, through respective antennas 30/42. Again, any combination of wired or wireless sensor arrays 10 is/are interfaced to the controller 40.

Note that the wireless connection is required to be at least in one direction, that is, from the sensor array's 10 transmitter 30 to the controller's receiver 260 so that data from the sensors 12/14/16 is transmitted to the controller 40. In some embodiments, there is a two-way communication instead of a one-way communication and the sensor array 10 and the controller both have transceivers 30/260. In this way, the controller 40 has the ability to signal the sensor array 10 to initiate a reading, to send results, etc.

It is also anticipated that other data be communicated between the sensor array 10 and the controller 40 such as battery status, identification numbers (e.g., in some embodiments, each sensor array 10 and/or each pair of density sensors 12/14 has a unique serial number to map sensor array 10 locations to transmitted signals, etc.).

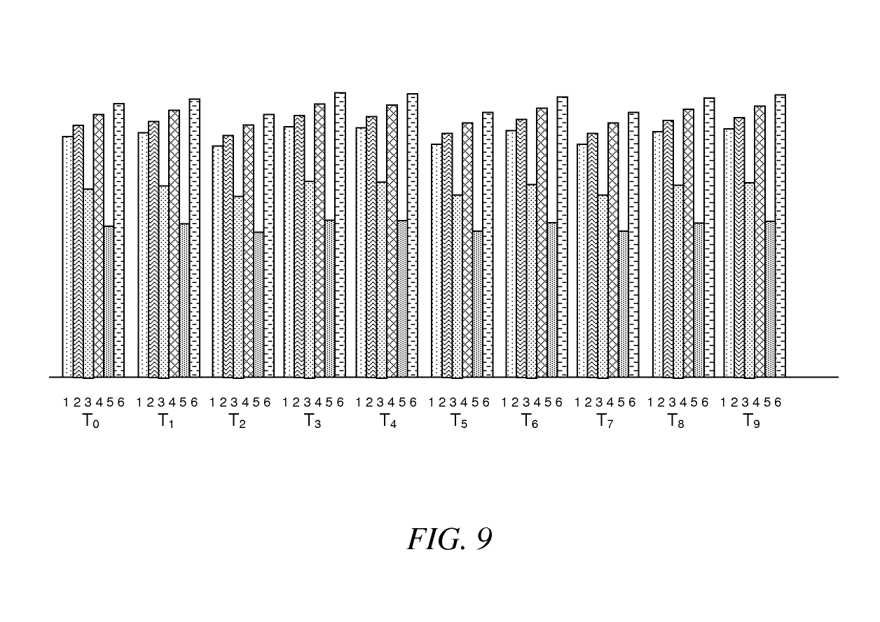

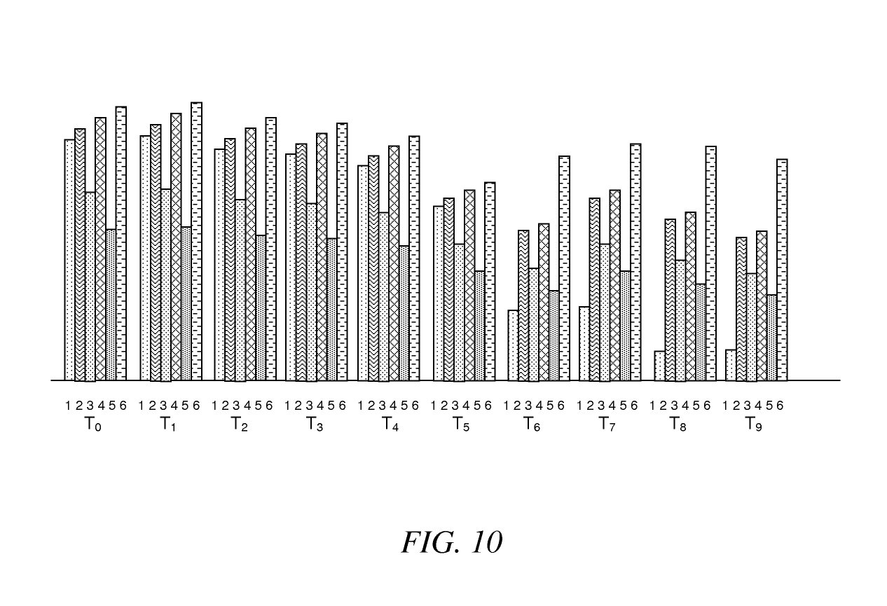

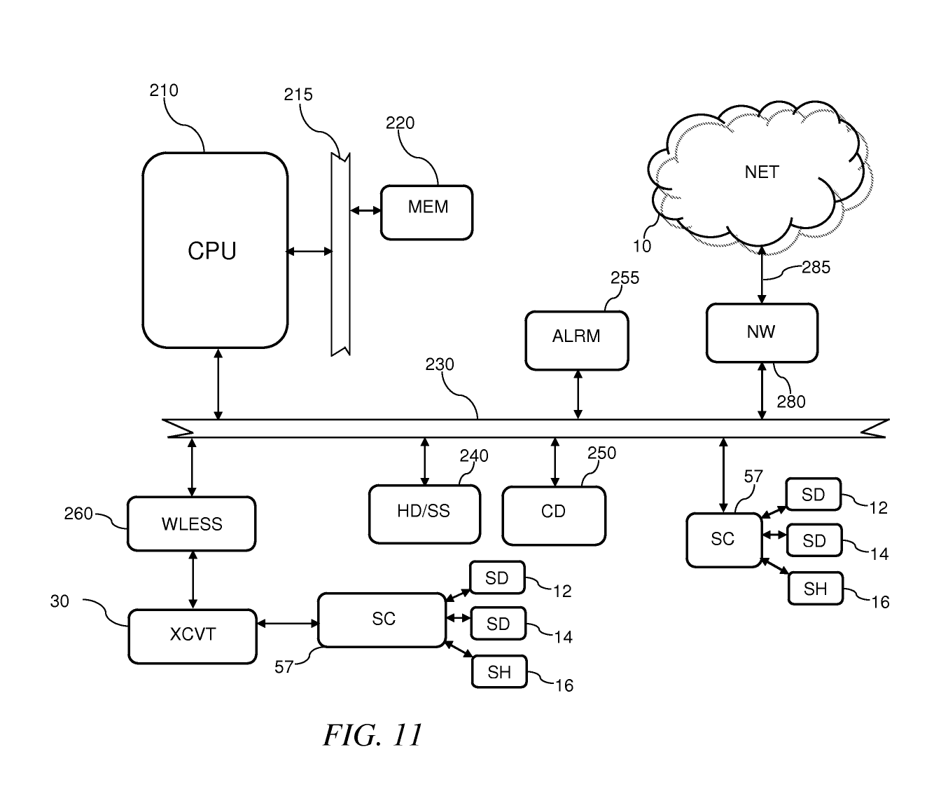

In this example, two datasets 44/46 are interfaced to the controller 40, preferably stored in non-volatile memory such as a hard disk or solid state memory 240 (see FIG. 11). The first data set 44 is collected density data 44 and thresholds. Each time a sensor array 10 reports any density or humidity data, the data is stored in the collected density data 44, for example in an array representing a histogram over time (see FIGS. 9 and 10). As will be described, an initial set of readings are read from the sensors 12/14/16 and stored in the collected density data 44, creating a baseline (or thresholds) from which, later readings are compared to determine if any issues or potential emergencies exist.

In steady-state operation, the controller collects data from the sensor arrays 10 and determines if the data is indicative of a potential sink hole development. In addition, in some embodiments, the controller 40 is connected to a network (e.g. the Internet) 100 and the controller 40 has the ability to extract information from external sources of data 110 such as weather services, news services, etc. In such embodiments, the controller 40 augments data from the sensor arrays 10 with weather, news, etc., to better understand the data from the sensors 12/14/16. For example, if the locale in which the sensor arrays 10 are located has had constant rain for many days, certain thresholds are modified slightly, or if the weather includes frost that requires farmers to spray their fields to prevent freezing of fruit, more frequent scanning of the sensors 12/14/16 is made, etc.

Having a connection to this network 100 provides the controller 40 with a path to the cellular network 130, through which optional alerts are transmitted to, for example, an assigned cellular phone 132. To facilitate notification, contact data 46 is maintained and administered (e.g. edited, changed) by the controller 40. The contact information 46 includes, for example, how to notify the correct person when a change occurs, when a building issue is occurring, or when a catastrophic situation is predicted, etc.

Having a connection to this network 100 also provides the controller 40 with a path to a remote computer 111, such as a remote computer 111 that is part of a service provider. In some embodiments, the controller 40 sends a transaction to a remote computer 111, encoded with, for example, an identification of the building, an identification of the sensor array 10 and/or sensor 12/14/16, some amount of data for analysis, an indication of severity, etc. From this transaction, the remote computer 111 optionally analyzes the data and takes appropriate action, including, but not limited to, dispatching technicians, notifying emergency personnel, notifying a contact for the building, etc.

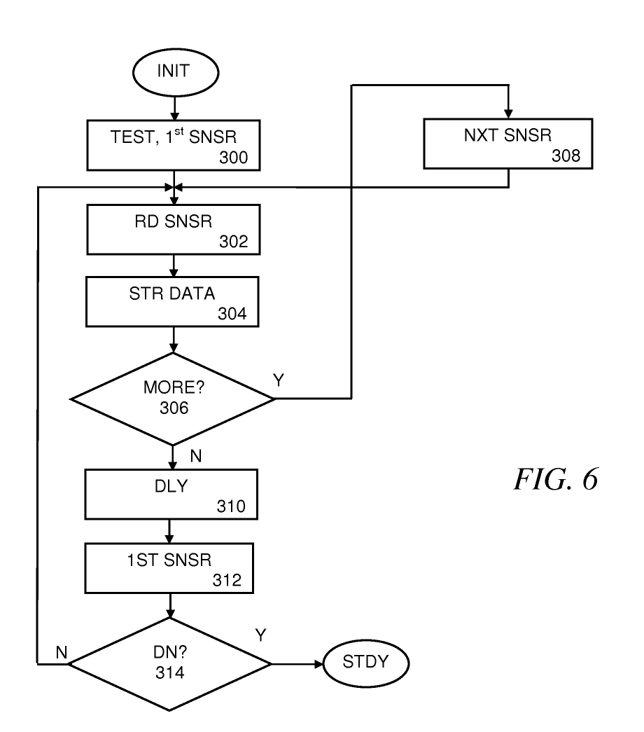

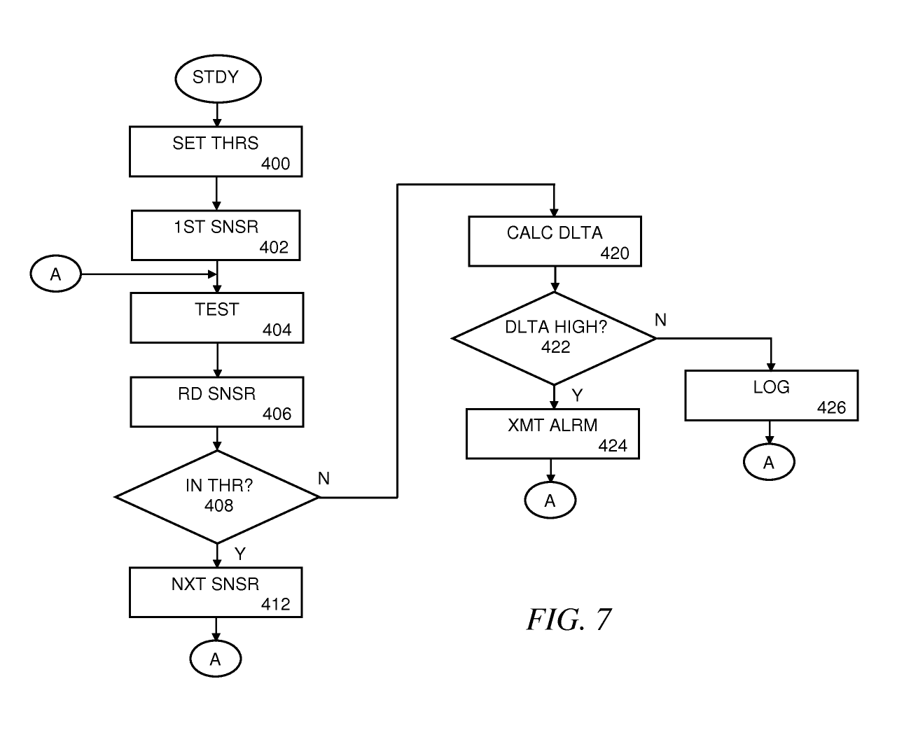

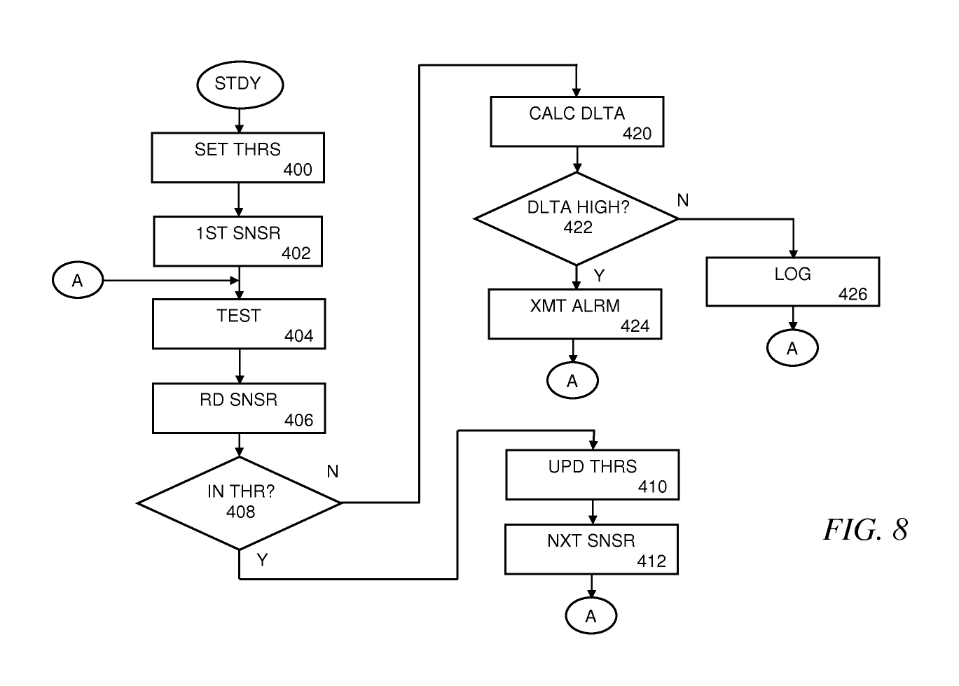

Referring to FIG. 6, a flow chart of software of the soil density detection system is shown. In this, a self-test 300 is optionally performed to make sure all sensors 12/14/16 and sensor arrays 10 are functioning and connected, and the first sensor 12/14/16 is addressed 300. Now, a loop is started to read 302 the current sensor and store 304 the data from that sensor in the density data 44. If more sensors are in the current configuration 306, the next sensor is addressed 308 and the loop continues. If there are no more sensors in the current configuration 306, then, a preferable, though optional, delay is taken 310 then the first sensor is again addressed 312. If initialization is not done 314, the reading 302 and storing 304, etc. is repeated until enough data is collected and the initialization is done 314, at which time the density study process begins (see FIGS. 7 and 8).

Referring to FIG. 7, a second flow chart of software of the soil density detection system is shown. A sufficient sample of data has been collected from the sensors 12/14/16, over some amount of time (see FIG. 6), and various thresholds are set 400. Since the density in front of each sensor pair 12/14 may be different due to the location of the sensor within the soil and/or the soil density to that side of the sensor array 10, etc., it is anticipated, but not required, that each density sensor pair 12/14 have a unique threshold that is maintained so that, each time that density sensor pair 12/14 is read, the value read is compared to the unique threshold for that density sensor pair 12/14.

Now the first sensor is addressed 402 and a loop is started.

The first step of the loop is optionally a test 404 to make sure the sensor 12/14/16 and/or transmitter is connected and operational. Next, the sensor 12/14/16 is read 406 and the data from that sensor 12/14/16 is compared to a threshold 408, preferably a threshold specific to that sensor 12/14/16. If the data is within expected limits 408, the next sensor is addressed 412 and the loop continues.

If the data is not within expected limits 408, variances are calculated 420 to determine how significant the current reading has changed with respect to the data stored in, for example, density data 44 in histograms or other structure. If the variance is significant 422 (e.g. an impeding sink hole is predicted), an alarm is made or transmitted 424. This consists of any notification mechanism known, including, but not limited to, sounding a sound device, lighting a light emitting device, making vibrations, sending an email, sending a text message 131 (see FIG. 16), making a pre-recorded voice call, and sending a transaction to a service computer 111. In the latter, it is anticipated that there be a service similar to that of alarm companies that receive potential sink hole indications and take action, including notifying occupants. In such, it is also anticipated that the service have access to prior sensor readings to better understand what is happening under the grade and to gain an understanding of the true severity of the situation. In some embodiments, the histogram data is uploaded to a larger computer (not shown) and further analyzed for potential problems.

If the current reading is above the threshold, but the severity is not deemed significant 422, then the issue is logged 426. In some embodiments, the logs are checked for some number of entries that imply some type of activity below the grade.

Referring to FIG. 8, a third flow chart of software of the soil density detection system is shown. This flow is similar to that of FIG. 7, except the histograms (or other data structures and thresholds) are further updated by subsequent data read from the sensors 12/14/16. Once sufficient samples of data has been collected from the sensors 12/14/16 over some amount of time (see FIG. 6), various thresholds are set 400. Since the density in front of each sensor pair 12/14 may vary due to the location of the sensor within the soil and/or the soil density to that side of the sensor array 10, etc., it is anticipated, but not required, that each density sensor pair 12/14 have a unique threshold that is maintained so that, each time that density sensor pair 12/14 is read, the value read is compared to the unique threshold for that density sensor pair 12/14.

Now the first sensor is addressed 402 and a loop is started.

The first step of the loop is optionally a test 404 to make sure the sensor 12/14/16 and/or transmitter is connected and operational. Next, the sensor 12/14/16 is read 406 and the data from that sensor 12/14/16 is compared to a threshold 408, preferably a threshold for that sensor 12/14/16. If the data is within expected limits 408, the thresholds are updated 410 and the next sensor is addressed 412 and the loop continues. In this example, the thresholds are updated 410 to allow for gradual shifting of the soil density from, for example, compacting from weight, vibration from vehicles, rain percolation, etc.

If the data is not within expected limits 408, variances are calculated 420 to determine how significant the current reading has changed with respect to the data stored in, for example, density data 44, as, for example, in histograms. If the variance is significant 422 (e.g. an impeding sink hole is predicted), an alarm is made or transmitted 424. This consists of any notification mechanism known, including sounding a sound device, lighting a light emitting device, making vibrations, sending an email, sending a text message, making a pre-recorded voice call, and sending a transaction to a service. In the latter, it is anticipated that there be a service similar to that of alarm companies that receive potential sink hole indications and take action, including notifying occupants. In such, it is also anticipated that the service have access to prior sensor readings to better understand what is happening under the grade and to gain an understanding of the true severity of the situation. In some embodiments, the histogram data is uploaded to a larger computer (not shown) and further analyzed for potential problems.

If the current reading is above the threshold, but the severity is not deemed significant 422, then the issue is logged 426. In some embodiments, the logs are checked for some number of entries that imply some type of activity below the grade.

Referring to FIG. 9, an exemplary histogram chart as read by sensors of the soil density detection system is shown. In these exemplary histograms, data for six sensors are shown numbered 1 through 6. The readings are taken over time periods T₁ through T₉. Any time period is anticipated such as hourly, daily, twice per day, weekly, etc., depending upon, perhaps, battery capacity, storage capacity of the controller 40, local area ground activity, water table activity, historical data, etc. For this example, assume the time period represent days. In this example the data recorded for the first day, T₀, is similar to the second day, T₁, and is similar to all days with minor variations. Therefore, there is a reasonable expectation that the subsoil is intact and there is no sink hole development.

Referring to FIG. 10, a second exemplary histogram chart as read by sensors of the soil density detection system is shown. In this example, the data recorded for the first day, T₀, is similar to the second day, T₁, but as days go by, significant reductions in soil density are found. For example, starting at T₆, the overall soil density from the first sensor (sensor 1) has dropped significantly and drops even more at T₈ and T₉, while the data from sensor 6 (humidity) remains substantially constant, meaning that there has been no significant change in soil water content. Therefore, there is a reasonable expectation that there is sink hole development. For example, what might be detected is a cavern forming in front of the first sensor, sensor 1, but not yet large enough to be well detected by the other sensors (2-5). In such, as described prior, this significant change in density will exceed the threshold and initiate an alarm notification. For example, such a change will initiate an email or text message to a homeowner or a transaction to a watch service. In the latter, it is expected that the homeowner (building owner) is notified and technicians are dispatched to the building to further server the situation. By knowing which sensor array or arrays 10 have experienced significant density reading changes, the technician is better able to pinpoint the potential sink hole and to further probe to understand the severity of the situation and, possibly take precautionary and repair measures such as evacuation, backfilling the cavity, injecting foaming polyurethane into the cavity, etc.

The above examples of histograms are for example only and are in no way limiting the data that is maintained and/or the format and structure of the data. For example, in a most minimal system, the data is only maintained until a threshold is determined, then subsequent readings are compared to that threshold, reducing the amount of data storage required. In a more robust system, every time the data is read, a time stamp and the data is stored in, for example, an array and the array is available for future study and analysis.

Referring to FIG. 11, a schematic view of a typical computer system 40 of the soil density detection system is shown. The example computer system 40 represents a typical controller or computer system 40 with interfaces for the sensor arrays 10. Although no keyboard or display is shown, such elements are well known in the industry. The example computer system 40 is shown in a simple form, having a single processor 210. Many different computer architectures are known that accomplish similar results in a similar fashion and the present invention is not limited in any way to any particular computer system 40. The present invention works well utilizing a single processor system as shown in FIG. 11, a multiple processor system where multiple processors share resources such as memory and storage, a multiple server system where several independent servers operate in parallel (perhaps having shared access to the data or any combination).

A processor 210 executes or runs stored programs that are generally stored for execution within a memory 220. The processor 210 is any processor or a group of processors, for example an Intel Pentium-4® CPU, controllers such as 80C51, or the like. The memory 220 is connected to the processor by, for example, a memory bus 215 and the memory 220 is any memory 220 suitable for connection with the selected processor 210, such as SRAM, DRAM, SDRAM, RDRAM, DDR, DDR-2, etc. Also, as shown, but not required, connected to the processor 210 is a system bus 230 for connecting to peripheral subsystems such as a network interface 280, a hard disk or other non-volatile storage 240 (e.g. flash), a disk drive (e.g. DVD, CD) 250, all of which are optional.

In general, the hard disk 240 is used to store programs, executable code and data persistently, while the disk drive 250 is used to load CD/DVD/Blue ray disk having programs, executable code and data onto the hard disk 240. These peripherals are examples of input/output devices, persistent storage and removable media storage. Other examples of persistent storage include core memory, FRAM, flash memory, etc. Other examples of removable media storage include CDRW, DVD, DVD writeable, Blueray, compact flash, thumb drives, other removable flash media, floppy disk, ZIP®, etc. In some embodiments, other devices are connected to the system through the system bus 230 or such are connected with other input-output connections/arrangements as known in the industry. Examples of these devices include printers; graphics tablets; joysticks; and communications adapters such as modems and Ethernet adapters.

In embodiments having a network connection, a network interface 280 connects the processor 210 to the network 100 through a link 285 which is, for example, a high speed link such as a cable broadband connection, a Digital Subscriber Loop (DSL) broadband connection, a T1 line or a T3 line, a wireless Wi-Fi connection, etc. Such a network interface is used as described with FIG. 5 to send notification signals to, for example, a cellular phone 132.

In some embodiments, a local alarm 255 is also included. Upon detection of a possible sink hole forming, the local alarm is activated, for example, making noise, light, vibrations, or signaling a local wireless device of the impending danger.

Any combination of wired or wireless sensor arrays 10 is anticipated. For wireless sensor arrays 10, the sensors 12/14/16 are interfaced to a wireless transmitter or transceiver 30 through, optionally, signal conditioners 57. The wireless transmitter/transceiver 30 wirelessly connects to a wireless receiver or transceiver 260, which in turn connects to the processor 210 through, for example, the bus 230. For wired sensor arrays 10, the sensors 12/14/16 are interfaced to one or more optional send/receive signal conditioners which in turn connects to the processor 210 through, for example, the bus 230.

Although not required, it is preferred that the sensor pairs 12/14 be sequenced, such that, one sensor pair 12/14 on a sensor array 10 is activated, then another, then another, and so on. In this way, there is less interference between sensor pairs 12/14.

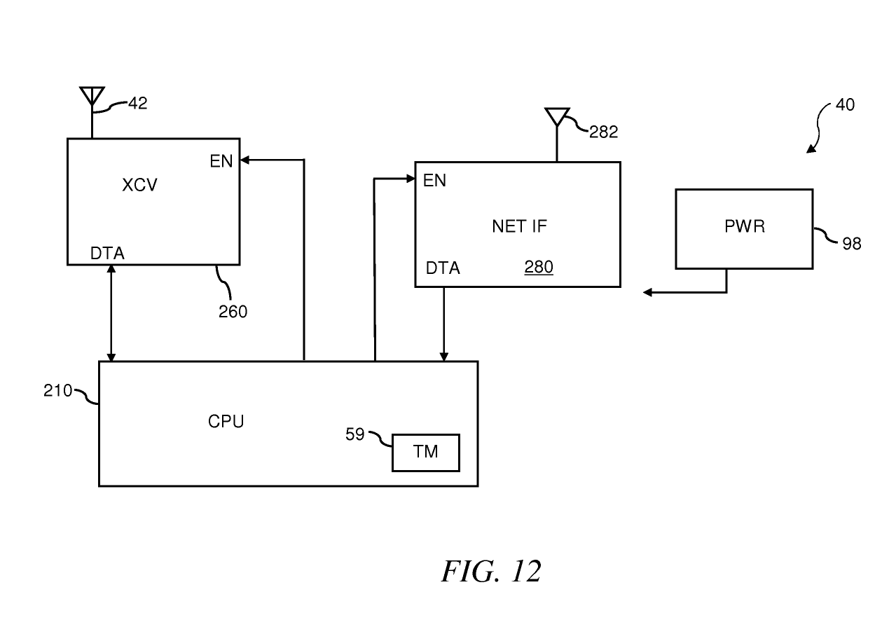

Referring to FIG. 12, a schematic view of an exemplary controller 40 of the soil density detection system is shown. Show is a minimal controller 40 having a processor 210 (other components from FIG. 11 are not shown for clarity reasons). A stored program in the processor communicates with a receiver or transceiver 260 to receive data from the sensor arrays 10 which is received/transmitted on an antenna 42. In some embodiments, the processor 210 disables the transceiver when not in use. In some embodiments, in which there is a transceiver 260, in addition to reading data from the individual sensors 12/14/16, the processor has transmit capability to instruct individual sensors 12/1416 to initiate density/humidity readings (e.g. polling), etc. In this, once a situation is detected (e.g. possibility of a sink hole), software running on the processor 210 has the ability to change the polling cycle and gather more data to better determine the severity of the issue and/or determine if other sensors 12/14/16 are becoming effected. Otherwise, in a non-polling configuration (one-way), each sensor array 10 controls when readings are made, making changing of the inter-reading interval difficult. In a polling configuration, it is anticipated that the processor have or have access to a timer 59 for initiating polling, etc.

In embodiments in which the controller 40 communicates with a network, a network interface 280 is provided. The network interface 280 provides wired or wireless connection to, for example, a Wi-Fi network, a wide area network (cellular), a local area network. When present, the network interface 280 communicates data, notifications, etc. In configurations in which the network is wireless, an antenna 282 is also provided, operatively coupled to the network interface 280. As above, the processor preferably has the ability to enable/disable the network interface 280 to, for example, save power.

Power 98 is provided and distributed to the components of the controller 40, for example an AC power supply 98, battery power 98, rechargeable battery power 98, AC power with battery backup 98, etc.

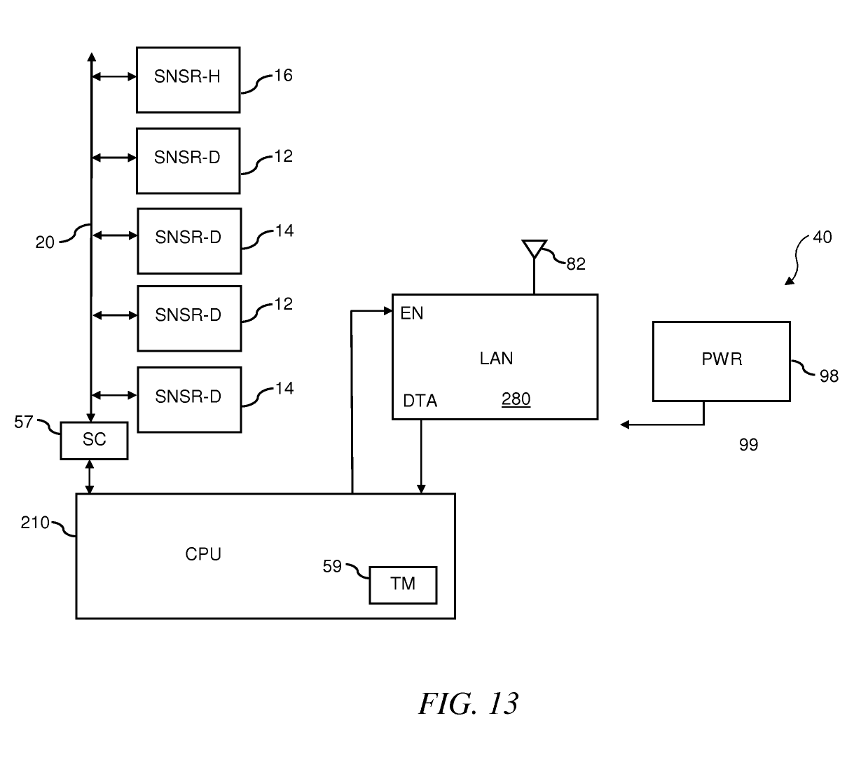

Referring to FIG. 13, a schematic view of an exemplary wired sensor array 10 of the soil density detection system is shown. Show is a minimal controller 40 having a processor 210 (other components from FIG. 11 are not shown for clarity reasons). A stored program in the processor 210 communicates with the sensors 12/14/16 through, optionally, a signal conditioner 57 which properly drives/terminates the sensors 12/14/16 and or multiplexes the signals to/from the sensors 12/14/16 over a number of wires 20. The processor 210 instructs individual sensors 12/14/16 to initiate density/humidity readings through the optional signal condition 57 and cables/bus 20. Software running on the processor 210 has the ability to change/adjust the polling cycle and gather more data to better determine the severity of an issue and/or determine if other sensors 12/14/16 are becoming effected. It is anticipated that the processor have or have access to a timer 59 for initiating polling, etc.

Although two density sensor pairs 12/14 and one moisture/humidity sensor 16 is shown, any number of sensors 12/14/16 connected to the processor 210 is anticipated.

In embodiments in which the controller 40 communicates with a network such as a Wi-Fi network, wide area network (cellular), local area network, etc., a network interface 280 is provided to communicate data, notifications, etc. In configurations in which the network is wireless, an antenna 282 is also provided, operatively coupled to the network interface 280. As above, the processor preferably has the ability to enable/disable the network interface 280 to, for example, save power.

Power 98 is provided and distributed to the components of the controller 40, for example an AC power supply 98, battery power 98, rechargeable battery power 98, AC power with battery backup 98, etc.

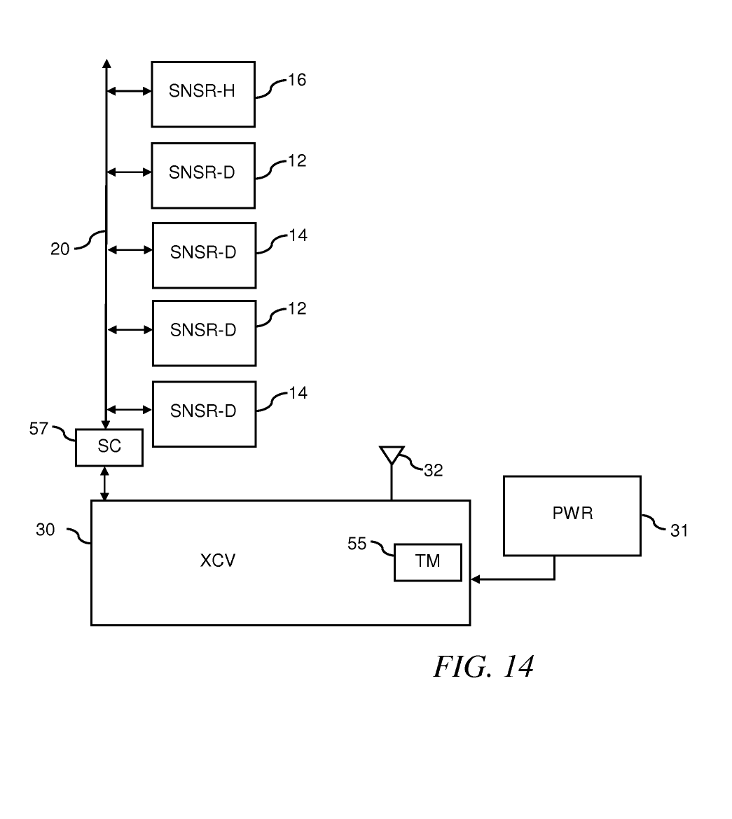

Referring to FIG. 14, a schematic view of a second exemplary wireless sensor array of the soil density detection system is shown. The transmitter or transceiver 30 communicates with the sensors 12/14/16, preferably through a signal conditioner 57 which properly drives/terminates the sensors 12/14/16 and or multiplexes the signals to/from the sensors 12/14/16 over a number of wires 20. The transmitter or transceiver 30 instructs individual sensors 12/14/16 to initiate density/humidity readings through the signal condition 57 and cables/bus 20. For non-polled systems, it is anticipated that the transmitter or transceiver 30 have or have access to a timer 55 for initiating polling, etc.

Although not required, it is anticipated that the transceiver 30 include a processor or micro-controller (not shown) for processing protocols, sequencing sensors 12/14/16, temporary storing data, etc.

Although two density sensor pairs 12/14 and one moisture/humidity sensor 16 is shown, any number of sensors 12/14/16 connected to the transmitter or transceiver 30 is anticipated.

The transmitter or transceiver 30 communicates with the controller 40 through a wireless connection using an antenna 32.

Power 98 is provided and distributed to the components of the sensor array 10 by, for example, battery power 31, solar power 31, combination rechargeable battery and solar power 31, etc.

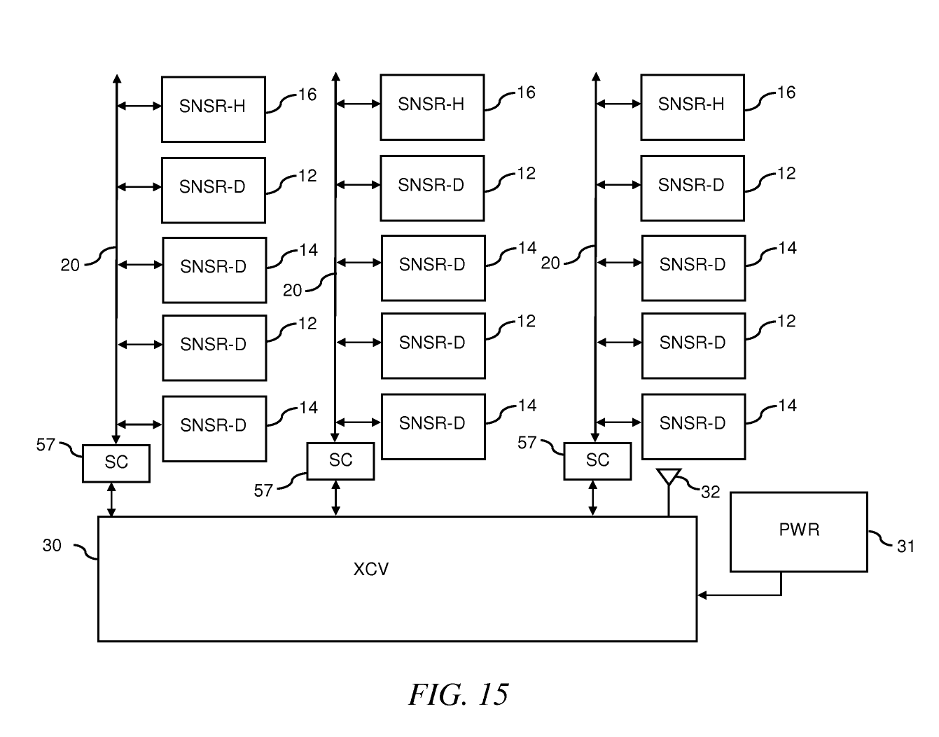

Referring to FIG. 15, a schematic view of an exemplary wireless sensor array 10 of the soil density detection system is shown. This wireless sensor array 10 is similar to the configuration of FIG. 14; except there are three separate sets of sensors 12/14/16 controlled by one transmitter/transceiver 30 and antenna 32. In this exemplary configuration, any number of sensors 12/14/16 is connected to each cable system 20 and to the transmitter/transceiver 30 through, for example, a signal conditioner 57. Similarly, other sets of sensors 12/14/16 are also connected to the transmitter/transceiver 30 and antenna 32 by additional cable systems 20 and through, for example, signal conditioners 57. In this way, any number of wireless sensor arrays 10 are wired to a central transmitter/transceiver 30 and antenna 32. Power 31 is supplied as above.

In some embodiments, the transmitter or transceiver 30 has fixed logic for selecting sensors 12/14/16, enabling sensors 12/14/16 and transmitting data while in other embodiments, the transmitter or transceiver 30 includes a micro controller or other processing element to control operation, implement transmission protocols, select sensors 12/14/16, enable sensors 12/14/16, transmit data, self-test, etc.

Referring to FIG. 16, a schematic view of an exemplary notification transmission 131 of the soil density detection system is shown. In this example, the notification transmission 131 is a text message such as a standard SMS text message shown displayed on a smart phone 132. In alternate embodiments, the notification signal is sent by any transmission mechanism available such as email, data transactions, radio frequency modulations, data transmissions to an application running on a smart phone 132, etc.

In this exemplary notification transmission 131, an indication of what has been detected 135 is included, such as a translation of predictions 135 based upon the rate of change of the sensor data, for example: “ground shift,” “sink hole forming,” “sink hole detected,” etc. In this example, a “ground shift” 135 was detected. Next, an identification 137 of the sensor array 10 and sensor 12/14/16 within that sensor array 10 is indicated. In this example, “sensor array 2.1” indicates the sensor 1 of the sensor array 2. This identification 137 correlates to one of the installed sensor arrays 10 on, for example, a map of the placements of the sensor arrays 10. Should there be a need, the serial number 139 of the sensor 12/14/16 or sensor array 10 is optionally displayed. In some embodiments, a severity 141 is displayed, for example, a severity 5 having a value of 1 indicates minor problems and a severity 5 having a value 10 indicates a severe problem and potential for loss of property and/or lives. Again, the notification message 131 shown is an example and other notification messages 131 are anticipated with more, less, and/or different content. In some embodiments, the controller 40 sends a transaction to a remote computer 111, encoded within the transaction is, for example, an identification of the building, an identification of the sensor array 10 and/or sensor 12/14/16, some amount of data for analysis, an indication of severity, etc. From this transaction, the remote computer 111 optionally analyzes the data and takes appropriate action, including, but not limited to, dispatching technicians, notifying emergency personnel, notifying a contact for the building, etc.

Although described in the context of sink hole detection, the soil density detection system is not limited to any particular application and other uses are equally anticipated such as data gathering, seismic studies, plate shift analysis, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A soil density monitoring system comprising:
a sensor pair having an emitting device and a receiving device, the emitting device emits a signal at a first time and the signal is reflected by soil and a reflected signal is detected by the receiving device at a second, later time;
whereas the sensor pair is positioned below grade such that a signal strength of the reflected signal and a signal delay between the first time and the second time are measured as an indication of the soil density.

2. The soil density monitoring system of claim 1, wherein the signal is an ultrasonic sound.

3. The soil density monitoring system of claim 1, wherein the signal is a sound.

4. The soil density monitoring system of claim 1, wherein the signal is radio frequency energy.

5. The soil density monitoring system of claim 1, further comprising a moisture sensor also positioned below the grade.

6. The soil density monitoring system of claim 5, further comprising a wireless transmitter operatively coupled to the sensor pair and a computer, the computer having a wireless receiver operatively coupled thereto, the wireless transmitter reading the signal strength and the signal delay and transmitting the signal strength and the signal delay to the wireless receiver for processing by the computer.

7. The soil density monitoring system of claim 5, further comprising a first wireless transceiver operatively coupled to the sensor pair and a computer, the computer having a second wireless transceiver operatively coupled thereto, the first wireless transceiver reading the signal strength and the signal delay and the first wireless transceiver transmitting the signal strength and the signal delay to the second wireless transceiver for processing by the computer.

8. A method of determining changes in soil density, the method comprising:
(a) providing at least one sensor pair comprising a signal emitter and signal receiver;
(b) installing the at least one sensor pair in soil below grade level;
(c) enabling one of the signal emitter to emit a signal, at least some of the signal reflecting off of the soil towards the signal receiver;
(d) receiving the reflected signal by the signal receiver; and
(e) recording a signal strength and signal delay which is the time between the enabling and the receiving.

9. The method of claim 8, wherein the steps (c) through (e) are repeated periodically over a period of time to accumulate baseline data and a signal strength threshold and a signal delay threshold are determined from the baseline data.

10. The method of claim 9, further comprising the steps of:
periodically repeating steps (c) and (e) and if the signal strength is less than the signal strength threshold or the signal delay is greater than the signal delay threshold, notifying a user.

11. The method of claim 10, wherein the notifying the user includes sending a text message to the user.

12. The method of claim 10, wherein the notifying the user includes sending a transaction to a service computer.

13. A soil density monitoring system comprising:
a computer system;
at least one sensor array located within the soil below a grade, each sensor array comprising one or more pairs of emitting devices and receiving devices, the emitting devices emit a signal at a first time and the signal is reflected by soil and a reflected signal strength is detected by the receiving device at a second, later time, a signal delay is between the first time and the second time;
the pairs of the emitting devices and the receiving devices are operatively coupled to the computer system by a wired or wireless connection; and
software executing in a tangible memory of the computer system, the software reading the reflected signal strengths and the signal delays;
whereas the reflected signal strengths and delays are related to a density of the soil in vicinity of each of the pairs of the emitting devices and the receiving devices.

14. The soil density monitoring system of claim 13, wherein the signal is an ultrasonic sound.

15. The soil density monitoring system of claim 13, wherein the signal is a sound.

16. The soil density monitoring system of claim 13, further comprising a moisture sensor also positioned below the grade.

17. The soil density monitoring system of claim 13, wherein the software records a plurality of the reflected signal strengths and the signal delays and determines a threshold for each pairs of emitting devices and a receiving devices based upon the recorded plurality of the reflected signal strengths and the signal delays.

18. The soil density monitoring system of claim 17, wherein after determining the thresholds, the software periodically reads the reflected signal strengths and the signal delays and compares the reflected signal strengths and the signal delays to the thresholds and, if any of the reflected signal strengths is lower than a signal strength threshold corresponding to a corresponding receiving device, and/or if any of the signal delays is higher than a delay threshold corresponding to a corresponding receiving device, the software issues a notification.

19. The soil density monitoring system of claim 18, wherein the notification consists of a message selected from the group consisting of a text message, an email, a voice message, and a computer-to-computer transaction.

20. The soil density monitoring system of claim 18, wherein after determining the thresholds, the software periodically reads the reflected signal strengths and the signal delays and compares the reflected signal strengths and the signal delays to the thresholds and, if any of the reflected signal strengths is lower than a signal strength threshold corresponding to a corresponding receiving device, and/or if any of the signal delays is higher than a delay threshold corresponding to a corresponding receiving device, the software issues a notification, then the thresholds are updated to include the reflected signal strengths and the signal delays.
